(19) United States
(12) Patent Application Publication
(10) Pub. No.: US 2006/0261562 A1
(43) Pub. Date: Nov. 23, 2006

(54) Compensating arbor or chuck

(75) Inventor: Sean C. Woodyard, Spencerport, NY (US)

Correspondence Address: THE GLEASON WORKS, 1000 UNIVERSITY AVENUE, P O BOX 22970, ROCHESTER, NY, 146922970, US

(73) Assignee: The Gleason Works

(21) Appl. No.: 11/437,967

(22) Filed: May 19, 2006

Related U.S. Application Data
(60) Provisional application No. 60/683,146, filed on May 20, 2005.

(51) Int. Cl. B23B 31/30

(52) U.S. Cl. 279/4.01

(57) ABSTRACT

A resilient means located within a tool or workpiece clamping device for accommodating increases in fluid volume due to heating of the clamping device thereby controlling internal pressure and preventing structural damage to the clamping device due to over pressurization.

This application claims the benefit of U.S. Provisional Patent Application No. 60/683,146 filed May 20, 2005, the entire disclosure of which is hereby incorporated by reference.

### FIELD OF THE INVENTION

The present invention is directed to tool or workpiece clamping devices, specifically, hydraulic arbors or chucks which include means to compensate for over pressurization of the arbor or chuck.

### BACKGROUND OF THE INVENTION

It is well known in machining, such as in the production of gears and other toothed articles, to secure a tool (for example, a hob) or a workpiece (such as a spur or helical gear) in position on a machine by the use of an arbor or chuck having an expandable gripping sleeve. A pressure medium, such as hydraulic fluid, is provided under pressure to the sleeve which then expands outward or inward to grip the respective inside or outside surface of the tool or workpiece.

As examples of the above, U.S. Pat. No. 3,762,730 to Cameron or U.S. Pat. No. 6,015,154 to Andre et al. teach expanding arbors with outwardly expending sleeves for gripping the inner surface of a tool or workpiece. Chuck devices such as those shown in U.S. Pat. No. 6,015,154 as well as in U.S. Pat. No. 5,088,746 to Dietz et al. or U.S. Pat. No. 5,286,042 to Laube include an inwardly expanding sleeve for gripping the outside surface of a workpiece or the shaft of a tool, for example.

One process for producing gears is hobbing. As the artisan is aware, hobbing is a continuous process in which a cutting tool, having spirally arranged teeth, and a workpiece rotate in a constant relationship to each other while the hob tool is fed, relatively, into the workpiece. For generating helical gears, the rotation of the workpiece is either slightly retarded or slightly accelerated in relation to the rotation of the hob. The hob is fed across the face of the workpiece once to completely form all teeth on the workpiece. The hob can be fed axially, radially, diagonally or tangentially depending upon the particular application and the machine options available.

In the production of gears, or other toothed articles, it is known to utilize a hobbing tool having a central bore extending the length of the hob. These types of hobs are known as shell type (or bore type) hobs and one means of securing shell type hobs on a hobbing machine is with the use of an expanding arbor. The hob is positioned such that the expanding sleeve of the arbor is located in the bore and the arbor is then expanded, usually with hydraulic fluid, whereby the expanding sleeve contacts the inside surface of the hob bore to grip the hob and hold it in position for cutting. Expanding arbors can also be utilized to grip the bore of a gear or gear blank (or a plurality or “stack” thereof) and hold it in position so that the gear can be machined, such as by hobbing.

As is known to the artisan, hobbing can be conducted with coolant (i.e. wet hobbing) or without coolant (i.e. dry hobbing). In dry hobbing, while most of the heat from the process is removed by the expelled chips, an appreciable amount of heat can build up in the hob, especially as the teeth of the hob become dull which tends to result in the hob running hotter. The same also applies to wet hobbing. In a similar manner, a workpiece being cut can become quite hot if the hob is becoming dull or if the workpiece is large thus requiring a significant amount of time that the hob is in contact with the workpiece. Also, several gears stacked together on an arbor for simultaneous machining can result in significant heat being generated due to the increased amount of stock material that is required to be removed and the increased amount of time the tool is engaged with the plurality of workpieces.

In any of the above instances, for example, heat from a tool or workpiece can be transferred to the arbor that is gripping the hob or workpiece causing the arbor temperature to rise which in turn causes an increase in the volume, and hence the pressure, of the hydraulic fluid in the arbor. The pressure in the hydraulic fluid can reach the point where seals in the arbor may break or the arbor itself may rupture with the potential of causing further damage to the hob and/or workpiece or the machine itself as well as injury to operating personnel. To date, therefore, expanding sleeve arbors have not been utilized for gripping hobbing tools on gear cutting machines due to the uncontrolled pressure increases encountered during machining.

### SUMMARY OF THE INVENTION

The present invention provides for means within a tool or workpiece clamping device for accommodating increases in fluid volume due to heating of the clamping device thereby controlling internal pressure and preventing structural damage to the clamping device due to over pressurization.

### BRIEF DESCRIPTION OF THE DRAWINGS

FIG. 1 is a lengthwise sectional view of the inventive clamping device.

FIG. 2 is an enlarged view of a first end of the clamping device of FIG. 1.

### DETAILED DESCRIPTION OF THE PREFERRED EMBODIMENTS

The present invention will now be discussed with reference to the accompanying drawing figures which should be understood to represent the invention by way of example only.

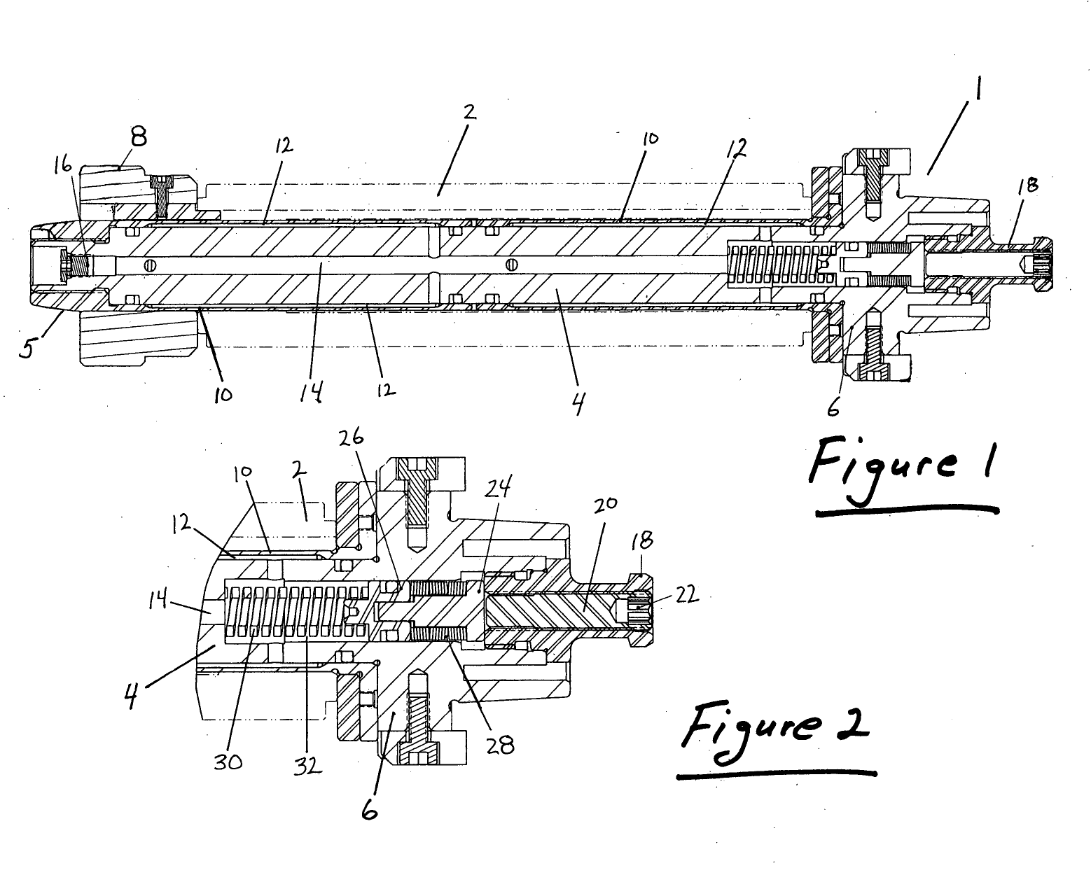

FIG. 1 illustrates a hob 2 (shown in outline only) positioned on the inner member or spear portion 4 of an expanding arbor 1. A first end of the inner member portion 4 is integral with arbor drive end 6 while the second end of inner member portion 4 includes an arbor cap 8 positioned thereabout. Arbor drive end 6 includes an arbor draw stem 18 which is gripped by a machine draw rod (not shown) when the arbor is mounted in a tool drive mechanism of a hobbing machine. The tapered outer surface 5 of the second end of inner member portion 4 is received in an outboard tool support (not shown) of the hobbing machine.

The inner member portion 4 includes one or more expanding sleeves 10 arranged along its length and spaced therefrom as shown by gap 12. Hydraulic fluid is supplied to the channels 14 and gaps 12 in the arbor via a filler opening in the second end of inner member portion 4 which is closed by a pressure plug 16. Thus, it can be seen that the hydraulic system of the arbor represents a “closed” system. Once a hob is positioned on the arbor, activator screw 20 is advanced such as by applying a predetermined amount of torque (e.g. 25 ft. lbs. such as by utilizing an Allen wrench at 22) thereby advancing pusher 24 (held in place against activator screw 20 by spring 30) to increase the pressure of the arbor to a predetermined working amount (e.g. 5000 psi at 20° C.). Such a pressure increase expands the sleeves 10 into contact with the inner surface of the hob 2 thereby securing the hob to the arbor for subsequent cutting of one or more gears.

As mentioned above, situations arise during machining that lead to heating of the arbor. For example, dulling of the hob can cause the temperature of the hob to rise thereby causing the temperature of the arbor to also increase. Hydraulic fluid in a closed arbor system will expand as it heats bringing about an increase in internal pressure of the arbor. Left unaddressed, the increased pressure can cause failure of the arbor seals or rupturing of the arbor sleeves or other components thereby putting the hob, machine and/or operator at risk.

The inventive arbor includes a pressure compensating system to address pressure increases in an expanding type tool or workpiece clamping device. As best seen in FIG. 2, the inventive arbor includes a hydraulic piston 26 and spring 28 (such as one or more Belleville springs) which react to the expanding volume of hydraulic fluid as it is heated (moves to the right in the Figures), effectively creating additional space in bore 32 for expansion of the fluid and thereby reducing the pressure increase in the arbor. For example, as the arbor in FIG. 1 or 2 is heated (e.g. from 20° C. to 120° C.), hydraulic fluid residing in the gaps 12 and channels 14 will likewise be heated and, therefore, will expand in volume. The expanding volume will bring about an accompanying increase in pressure which, left unchecked, can bring catastrophic results to the arbor.

In the inventive arbor, as heated hydraulic fluid expands and pressure builds, piston 26 is urged to move against the force of spring 28. Such piston movement effectively increases the available space in bore 32 for the expanding volume of fluid thereby minimizing the increase in pressure. For example, with the 100° C. temperature increase (noted above) and a hydraulic fluid having a coefficient of thermal expansion of 0.00064 per degree C., the volume change of fluid in the arbor will be 0.147 cubic inch. However, due to the volume change brought about by movement of the piston 26 against spring 28, a change in pressure of 980 psi is noted, thus bringing the internal arbor pressure to 5980 psi, well within the operating limits of the arbor which is generally around 7500 psi, for example, although the operational limit can vary depending on the design parameters as will be understood by the skilled artisan. If the inventive piston and spring arrangement were not provided, the arbor pressure would rise uncontrollably resulting in damage or destruction to the arbor or surrounding components and/or injury to personnel.

Although the above example relates to an arbor for holding a tool, the same principles are equally applicable to an arbor for holding one or more workpieces as well as to a chuck which expands inward to grip a tool or workpiece. Furthermore, while the preferred embodiment has been discussed with respect to including a piston and spring as the mechanism for reacting to fluid volume expansion, other appropriate mechanism may be utilized such as an independent hydraulic cylinder. Resilient means other than Belleville springs may be utilized such as die springs or elastomeric springs.

The piston 26 and spring 28 arrangement need not be located “in-line” with the activator screw 20 and pusher 24. Instead, piston 26 and spring 28 may be located at any location in the expanding arbor 1 as long as they maintain contact with the fluid in the arbor. Also, instead of applying a set amount of torque to actuator screw 20, the screw 20 may be advanced to a fixed depth to initially pressurize the system and a second actuator screw may be included with the piston and spring arrangement at another location. The second actuator screw could be set to a desired depth or torque to control the pressure increase in the arbor as it is heated. It can be understood that springs could be selected and/or the actuator screw could be appropriately set such that all or nearly all of the pressure build-up could be absorbed by the springs resulting in a net pressure gain of zero or nearly zero as the arbor is heated.

Although the above discussion has been with respect to volume and pressure increases due to heating of an expanding sleeve arbor or chuck, the present invention also applies to volume and pressure decreases such as when a workpiece is loaded onto a “hot” arbor and the arbor is allowed to cool prior to machining. Also, for example, a non-metallic (e.g. plastic) workpiece may be brought to and machined at below-ambient temperatures (e.g. bathed in liquid nitrogen) to bring about properties in the workpiece that approach those of metal so as to gain acceptable machinability. In such instances, cooling of the fluid in the arbor would present a volume and pressure decrease which would be countered by the piston and spring working in reverse to decrease the overall volume of the fluid system causing a controlled decrease in system pressure thereby avoiding an abrupt drop in system pressure which can cause damage to the arbor.

With the present invention, the heretofore exclusion of expandable sleeve arbors for gripping hobbing tools in gear cutting operations has been overcome in light of the pressure control mechanism discussed above.

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. A tool or workpiece clamping device for a machine tool, said clamping device comprising:
at least one gripping sleeve expandable by pressurizing a fluid;
a region within said clamping device wherein said fluid resides, said region defining a volume that is adjustable whereby decreasing said volume by a predetermined amount provides for an increase in fluid pressure to a predetermined working pressure thereby resulting in the expansion of said at least one gripping sleeve for clamping said tool or workpiece;
a pressure compensating means communicating with said fluid, said compensating means being reactive to an increase in fluid pressure beyond the predetermined working pressure, whereby the pressure of said fluid is maintained within a range between the predetermined working pressure and a predetermined operational limit pressure for said clamping device.

2. The clamping device of claim 1 wherein said pressure compensating means comprises a bore containing a piston and spring, said piston moving against the force of said spring in response to said increase in fluid pressure thereby effecting an increase in the volume of said region and a resulting decrease of fluid pressure.

3. The clamping device of claim 1 wherein said pressure compensating means comprises a bore containing a hydraulic cylinder, said cylinder moving in response to said increase in fluid pressure thereby effecting an increase in the volume of said region and a resulting decrease of fluid pressure.

4. The clamping device of claim 1 wherein said compensating means maintains the fluid pressure at the predetermined working pressure.

5. The clamping device of claim 1 further including said pressure compensating means being reactive to decreasing pressure by decreasing the volume of said region to counteract the decreasing pressure.

6. A tool or workpiece clamping device for a machine tool, said clamping device comprising:
at least one gripping sleeve expandable by pressurizing a fluid;
a region within said clamping device wherein said fluid resides, said region defining a volume that is adjustable whereby decreasing said volume by a predetermined amount provides for an increase in fluid pressure to a predetermined working pressure thereby resulting in the expansion of said at least one gripping sleeve for clamping said tool or workpiece;
a pressure compensating means comprising a bore containing a piston and spring communicating with said fluid, said piston moving against the force of said spring in response to said increase in fluid pressure beyond the predetermined working pressure thereby effecting an increase in the volume of said region and a resulting decrease of fluid pressure, whereby the pressure of said fluid is maintained within a range between the predetermined working pressure and a predetermined operational limit pressure for said clamping device.
